(19) United States
(12) Patent Application Publication
(10) Pub. No.: US 2003/0140926 A1
(43) Pub. Date: Jul. 31, 2003

(54) Chair for copulating couples

(76) Inventor: Normand Beaudet, Blainville (CA)

Correspondence Address: Normand Beaudet, c/o PROTECTIONS EQUINOX INT'L INC., Suite 224, 4480, Cote-de-Liesse, Montreal, QC, H4N 2R1, CA

(21) Appl. No.: 10/345,477

(22) Filed: Jan. 17, 2003

Related U.S. Application Data
(60) Provisional application No. 60/350,963, filed on Jan. 25, 2002.

(51) Int. Cl. A61G 15/00

(52) U.S. Cl. 128/845

(57) ABSTRACT

Chair for copulating couples having a support body and two legs attached to the support body. The support body of the chair supports a first couple member and has at least one generally concave contour located in a support body edge. The genitals of the first couple member are located adjacent the contour during copulation and in contact with the genitals of a second couple member. The chair includes a rocker portion for rocking the chair back and forth on a surface. The rocker portion is located on a surface contact portion of each leg and the chair rocks back and forth allowing sexual stimulation of each couple member.

### CROSS REFERENCE TO RELATED APPLICATION

Benefit of U.S. Provisional Application for Patent, Serial No. 60/350,963, filed on Jan. 25, 2002, is hereby claimed and is incorporated by reference in its entirety.

### FIELD OF THE INVENTION

The present invention concerns chairs, more particularly to chairs for use by copulating couples.

### BACKGROUND OF THE INVENTION

Sexual intercourse over prolonged periods of time often causes fatigue in the muscles of the lower extremities, particularly the lower limbs, rapidly bringing about discomfort. Certain sexual positions accentuate this discomfort, for example in positions where the female sits on the male. In addition, sexual relations in the infirm, partially handicapped people, obese people and women in the late stages of pregnancy are often uncomfortable and limited in their variety. Aids for improving the comfort and variety of sexual relations in the aforesaid and in able-bodied people are limited. An example of one such aid is U.S. Pat. No. 3,971,592, issued to Farley on Jul. 27, 1976, which discloses a chair for aiding sexual relations in the infirm. The chair is of a complex design and while it appears as though the chair seat is useful for movement along a generally vertical plane, it may not be ergonomically favorable to certain sexual positions and activities. Furthermore, a lower portion of a chair frame is flat, which may limit the users to rely on leg movement to move the move the chair seat up and down. Moreover the chair design may be prone to wear and tear along a rectangular genital access orifice that is stitched into a fabric seating area.

Thus there is a need for an improved chair that reduces fatigue and increases the variety of sexual positions and activities.

### SUMMARY OF THE INVENTION

The present invention is directed towards a solution to the aforesaid problems.

The invention provides a simple chair that can be used by copulating couples that is both simple to use and inexpensive to manufacture. Advantageously, the chair provides a novel concave recess for improved genital comfort during sexual intercourse and also a means by which the chair can rock back and forth, thus alleviating discomfort and fatigue in the lower extremities. In addition, the chair ergonomically favors sexual intercourse in many positions by providing, in addition to the concave contours, novel genital access openings in a seating area. Moreover, the chair allows the full body weight if the female to be supported during sexual intercourse, thus significantly reducing fatigue in the lower extremities. The chair also provides increased comfort and variety of sexual positions to the infirm, people who are partially handicapped, people who are obese and to women who are in the late stages of pregnancy. Moreover, the chair also provides increased comfort to men with lower back problems by fully supporting the weight of the female during copulation.

In a first aspect of the invention, there is provided a chair for copulating couples, said chair having a support body and two legs attached to said support body, said chair comprising: said support body for supporting a first couple member, said support body having at least one generally concave contour located in a support body edge, the genitals of said first couple member being located adjacent said contour during copulation and in contact with the genitals of a second couple member; and a rocker portion for rocking said chair back and forth on a surface, said rocker portion being located on a surface contact portion of each leg, said rocking back and forth allowing sexual stimulation of each couple member.

Typically, the chair described above includes a first generally concave contour and a second generally concave contour. The contour includes a contour sidewall, which includes two arcuate edges, which interconnect upper and lower support body surfaces.

Typically, the contour is of sufficient size to allow said first and second couple members to comfortably position their genitals against said first contour during copulation.

Typically, the second contour is opposite said first contour and has generally the same size as said first contour.

Typically, the support body edge includes a first longitudinal edge portion and a second longitudinal edge portion. The second longitudinal edge portion is located opposite said first longitudinal edge portion. The first and second longitudinal edge portions define a generally planar chair portion.

Typically, the first longitudinal edge portion has a first height and said second longitudinal edge portion has a second height, said second height being larger than said first height.

Typically, the support body edge further includes two connecting edge portions for connecting each leg thereto. The connecting edge portions are spaced apart, each leg depending therefrom.

Typically, the support body further includes a first support body opening and a second support body opening. The support body opening includes a body opening sidewall and a support body opening axis is parallel to said contour axis. The first support body opening is spaced apart from said second support body opening.

Typically, the support body openings are located adjacent said first and second contours. The support body openings are located between each connecting portion and each of said contour.

Typically, each leg includes: a distal leg portion; a proximal leg portion; and an intermediate leg portion interconnecting said distal and proximal leg portions. The distal leg portion is connected to said surface contacting portion.

Typically, the distal leg portion is wider than said proximal leg portion.

Typically, the surface contacting portion defines a generally curved surface of sufficient size to allow said chair to rocking back and forth. The curved surface has an surface contacting axis about which said curved surface rocks, said axis being generally parallel to said surface.

Typically, each leg includes a height adjusting member for adjusting the height of said support body relative to said surface. The height adjusting member is located in said proximal leg portion.

In another aspects of the present invention, each leg includes a handle member.

Typically, said handle member includes a recess located in said distal leg portion.

Typically said handle member further includes a front gripping bar located in the intermediate leg portion.

Typically, said handle member further includes a rear gripping bar located in said intermediate leg portion.

Typically, said handle member further includes a central gripping bar located in said intermediate leg portion. The central gripping bar interconnects said front and rear gripping bars.

Typically, the support body is angled away from a horizontal support body plane towards said surface.

Other objects and advantages of the present invention will become apparent from the detailed description provided herein, with appropriate reference to the accompanying drawings.

### BRIEF DESCRIPTION OF THE FIGURES

Further aspects and advantages of the present invention will become better understood with reference to the description in association with the following Figures, wherein:

In the annexed drawings, like reference characters indicate like elements throughout.

FIG. 1 is a perspective view of a first embodiment of chair of the invention;

FIG. 1a is a perspective view of the embodiment of FIG. 1 in operation;

FIG. 1b is an exploded perspective view of FIG. 1;

FIG. 2 is a perspective view of an alternative embodiment of FIG. 1;

FIG. 3 is a cross-sectional view taken along line 3-3 in FIG. 1;

FIG. 4 is a perspective view of a second embodiment of the invention;

FIG. 4a is a perspective view of the embodiment in FIG. 4 in operation;

FIG. 5 is an exploded perspective view of FIG. 4;

FIG. 6 is a side view of a third embodiment of the invention;

FIG. 7 is a top view of FIG. 6; and

FIG. 8 is a rear view of FIG. 6.

### DETAILED DESCRIPTION OF THE INVENTION

Preferred Embodiments

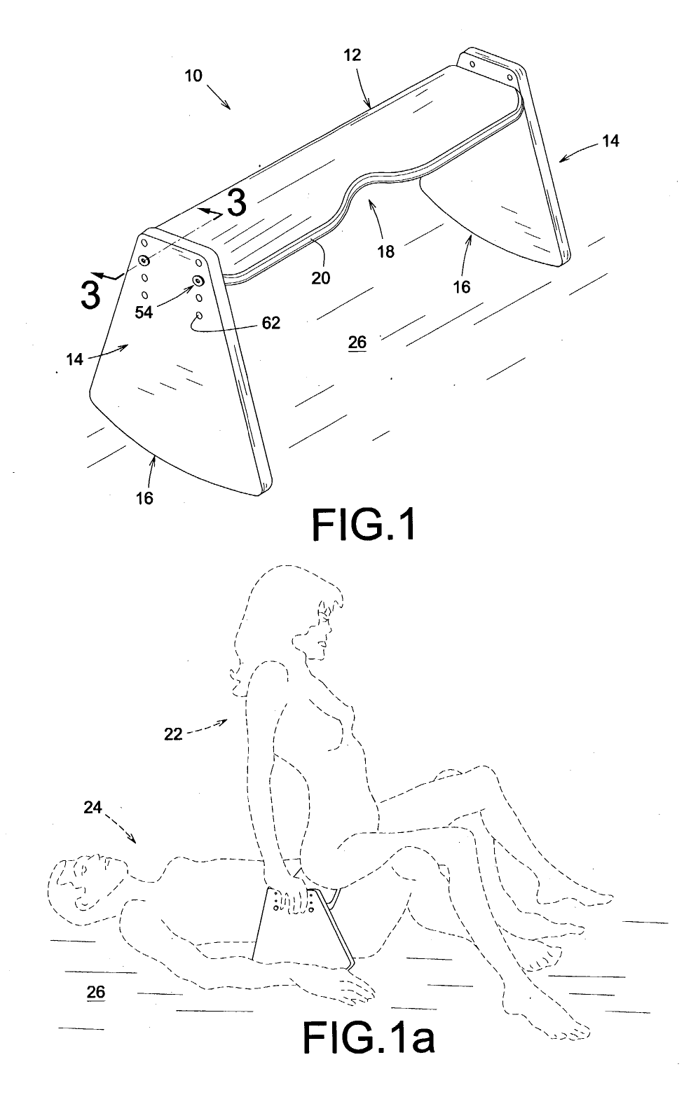

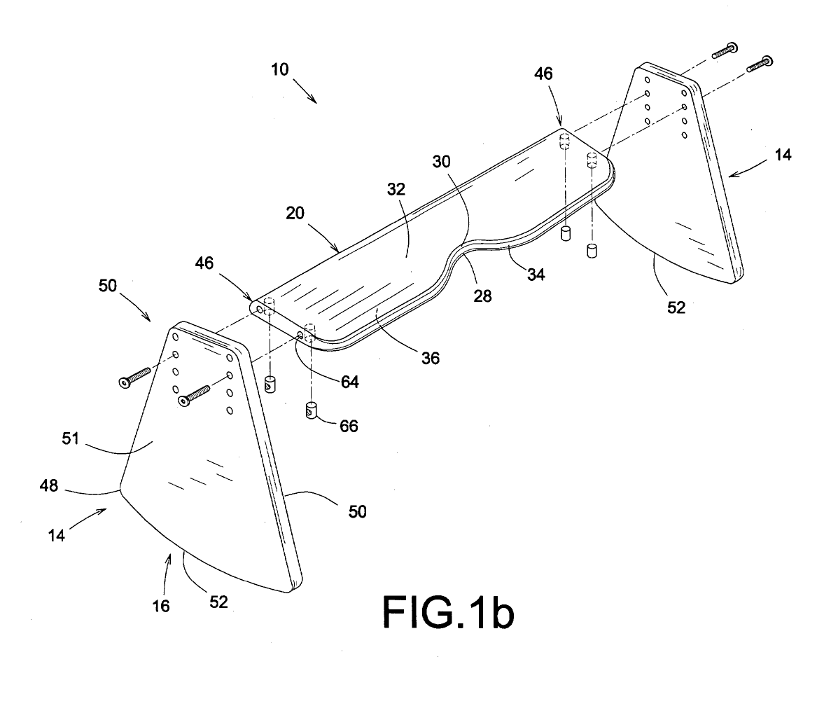

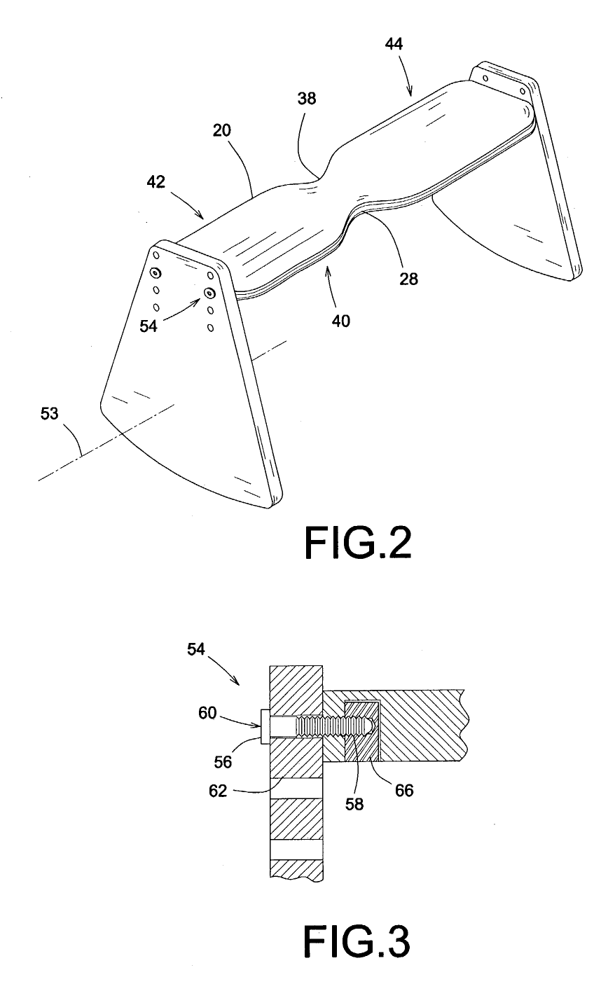

FIGS. 1 and 2 illustrate a first embodiment of the invention in which a chair for use by copulating couples is shown generally at 10. The chair 10 includes a support body 12, two legs 14, a rocking portion 16, and a first concave contour 18.

The support body 12 has a support body edge 20 in which the first generally concave contour 18 is located. The first concave contour 18 is sized to allow the genitals of a first couple member 22, normally the female, to be located adjacent and supported by the contoured edge during copulation. The female may be seated on the support body 12, which has sufficient strength to support the female body weight during sexual intercourse. A second member 24 of the couple, normally the male, may be in the supine position, lying on a flat surface 26 underneath the female 22.

The first generally concave contour 18 includes a contour sidewall 28 and a first arcuate edge 30. The smooth arcuate edge 30 allows the female 22 to comfortably position her genitals against the contour 18 during copulation. The arcuate edge 30 interconnects an upper support body surface 32 with the contour sidewall 28. The contour sidewall 28 may also include a second arcuate edge 34, which interconnects the contour sidewall 28 with a lower support body 36, against which the male genitals may be positioned comfortable during copulation. Both the arcuate edges 30 and 34 interconnect the sidewall 28 with the upper and lower support body surfaces 32 and 36 to for smooth and comfortable genital contact zones.

A second generally concave contour 38, shown in FIG. 2 is located in the support body edge 20 and opposite the first generally concave contour 18. The second contour 38 has approximately the same size and dimensions as the first contour 18.

The support body edge 20 includes a first front longitudinal edge portion 40 and a second rear longitudinal edge portion 42 opposite 40. Both the edge portions 40 and 42 define a planar seat portion 44. The upper and lower support body portions 32, 36 further define the seat portion 44. The rear edge portion 42 has a height that is greater than the front edge portion 40, which gives the seat portion a wedge-shape in cross-section (not illustrated). Similarly, the second contour sidewall height is greater than the first contour sidewall height.

Referring to FIG. 1b, the support body edge 20 also includes two connecting edge portions 46 located at opposite ends of the edge portion 20 to which each of said legs 14 is attached. The support body 12 and the legs 14 define a space therebetween, which is of sufficient size to allow the male 24 to be positioned supine in the space.

Each leg 14 includes a distal leg portion 48 and a proximal leg portion 50. The distal leg portion 48 includes the rocker portion 16 located on a surface contacting portion 52 of the leg 14. The rocker 16 rockingly engages the surface 26 and allows the female 22, whilst seated, to rock the chair 10 back and forth during copulation with the male 24. Generally, the distal leg portion 48 is wider than the proximal leg portion 50. An intermediate leg portion 51 interconnects the distal and proximal legs portions. The surface contacting portion 52 is a generally curved surface of sufficient size to allow the chair 10 to rock back and forth without tipping over. The curved surface has a surface axis 53, which is generally parallel to the surface 26, about which the curved surface rocks.

The proximal leg portion 50 includes a height adjusting member 54, as shown in FIG. 1b, to allow the height of the support body 12 relative to the surface 26 to be varied. This enables the support body 12 be moved towards and away from the male 24 depending on the desired sexual position and/or the size of both partners. In its highest position, the support body 12 allows the male 24 to have control over his movement. In the lower positions, the genitals of both the male and female are in closer contact, thereby increasing sexual stimulation. The support body 12 is slightly inclined from the horizontal towards the surface 26 to enhance comfort of the user, which in conjunction with the wedge shape of the support body 12 optimizes the proximity of the genitals.

Referring to FIG. 3, the height adjustment member 54 includes securing member 56, which comprises a nut and bolt-type fastener 58, which allows the user to quickly assemble and disassemble the chair 10. A bolt 60 is inserted into one of a number of bores 62 in the support body 12 and extends through a support body bore 64 and is secured in situ by a nut 66. Those skilled in the art will recognize that many types of quick release height adjusters are available to achieve the same result without deviating from the scope of the invention, for example, hydraulic pumps, ratchet and pawls, and locking devices.

The chair 10 may be constructed from rigid, inexpensive, lightweight materials, which are easily cleaned, such as finished wood, Plexiglas™ or a molded-type thermoplastic material. The chair 10 when constructed must be of sufficient strength to support a user for a prolonged period of time. For increased comfort to the user, a molded chair cushion (not shown) may be attached to the seat portion 36 using a quick release fabric such as Velcro™. The molded chair cushion may have a contour therein that is complimentary to one or both contours 18 and 38.

Operation

The chair 10 is usually supplied as illustrated in FIG. 1. During copulation, the male 24 may lie supine on the surface while the female 22 positions the chair 10 over the male 24. The height of the seat support body 12 relative to the surface 26 and the male 24 may be adjusted using the height adjustment member 54 as described above. The female 22 sits on the seat portion 44 of the support body 12 and may steady herself by holding onto the front of the legs 14. Both the male and female adjust their respective positions to allow their genitals to contact. The female 22 then rocks the chair 10 back and forth for sexual stimulation.

Alternatives

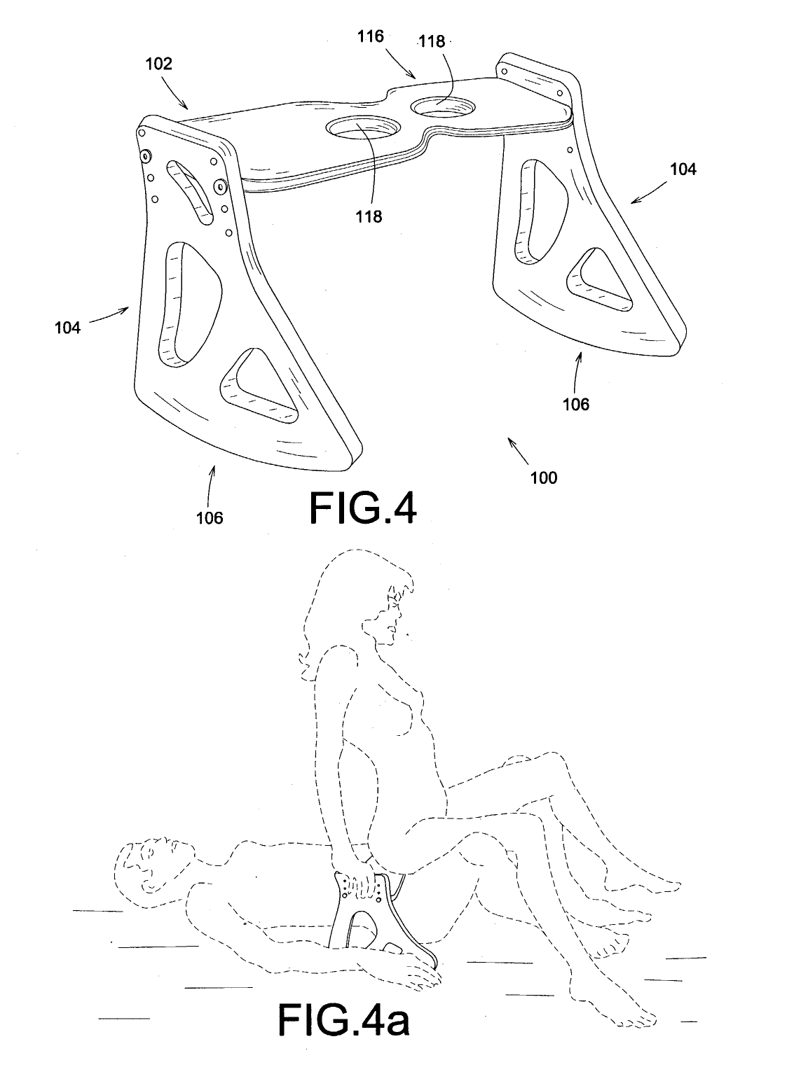

The first embodiment 10 allows the female 22 to rock back and forth whilst the male 24 is in a supine position. There may be times when both couple members need more control in different sexual positions. A second embodiment 100, illustrated in FIGS. 4 and 4a operates in essentially the same way as the first embodiment 10, yet provides for a wider variety of sexual positions with increased comfort for the female. The second embodiment of the invention will now be described.

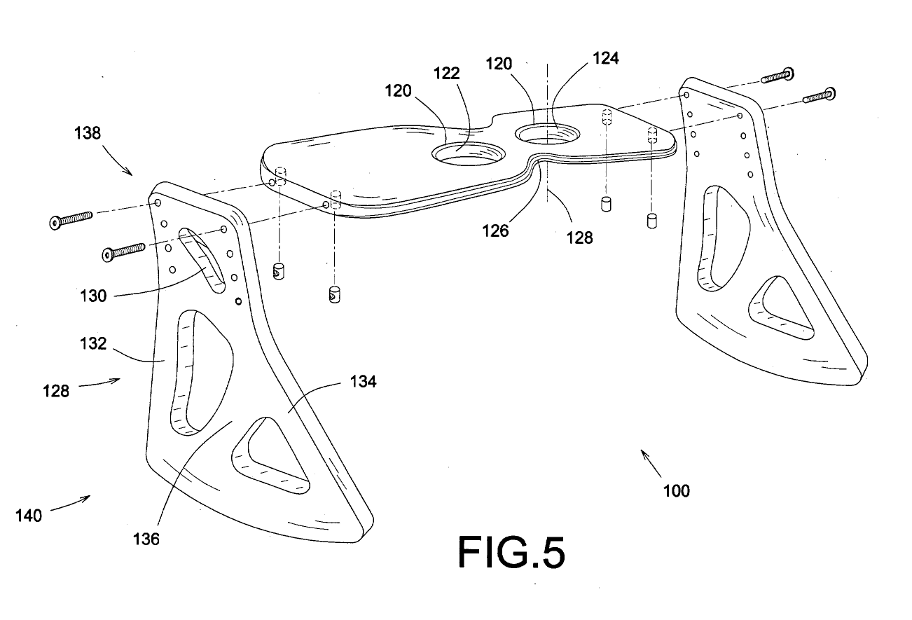

The chair 100 is shown generally at 100 and is essentially of the same construction as the first embodiment 10 and includes a support body 102, two legs 104, and a rocking portion 106. The differences will now be described with reference to FIGS. 4 and 5. The support body 102 includes, in a generally planar seat portion 116, which includes two spaced apart support body openings (genital access ports) 118. Each opening 118 has a body opening sidewall 120 and a first rounded annular edge 122. The seat openings 118 have a size sufficient to allow the buttocks of the female to be supported therein and also to allow the genitals of both the male and the female to fit therethrough. The seat openings are typically about six (6) centimeters to about ten (10) centimeters in diameter. The first annular rounded edge 122 interconnects the body opening sidewall 120 with the upper support body surface. The body opening sidewall also includes a second annular edge 124, which interconnects the body opening sidewall with the lower support body surface. Each of the annular edges 122 and 124 has an arcuate edge 126, which is rounded and smooth for comfort as described above.

Each seat opening 118 includes a body opening axis 128 generally parallel to first and second generally concave contour axes. The seat opening 118 is located on either side of the first and second generally concave contours 126, between the connecting portions. The seat openings 118 are generally elliptical. The seat openings 118 are sized to accommodate plugs (not shown) therein that may fill the openings when they are not required for use.

Each leg 104 includes handle member 128, which comprises a recess 130, a rear gripping bar 132, a front gripping bar 134 and a central gripping bar 136. The recess 130 is located in a proximal leg portion 138. The gripping bars 132, 134 and 136 are located in an intermediate leg portion 140. The central gripping bar interconnects the front and rear gripping bars and is generally angled down towards the surface to provide for more controlled rocking by the female. The recess 130 is of sufficient size to allow gripping by the hand during copulation or for carrying the chair.

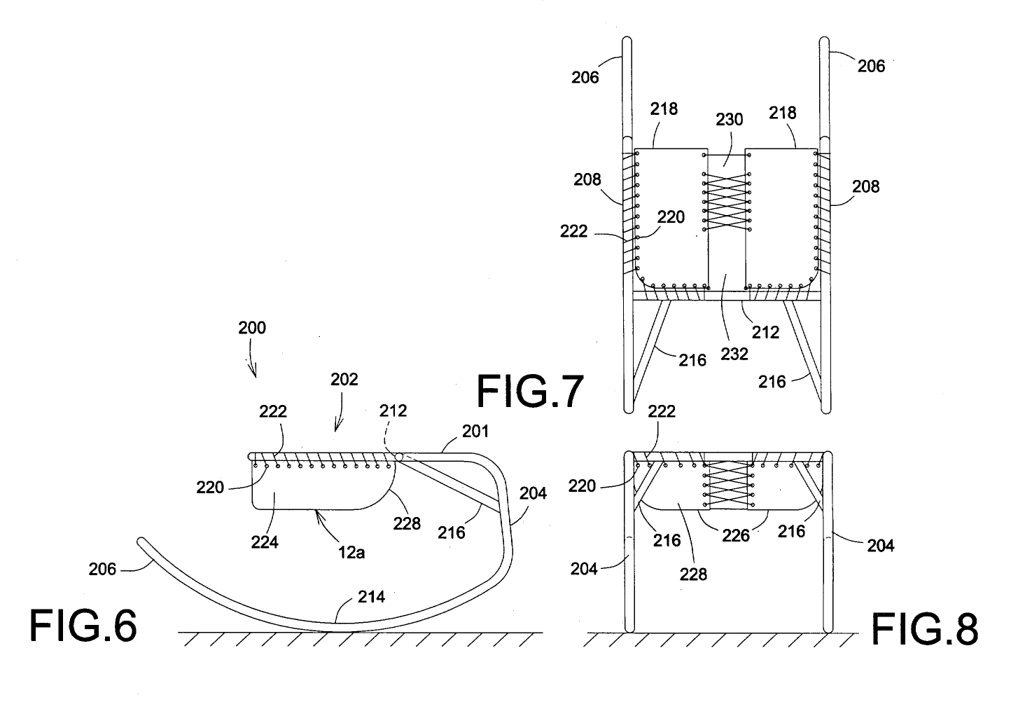

Now referring to FIGS. 6, 7, and 8, there is shown a third embodiment 200 of a chair for copulating couples in accordance with the present invention. The chair 200 is constructed differently than either of 10 or 100 described above. The chair 200 includes a unitary frame 201 having a support portion 202, two rearwardly disposed leg portions 204 and a rocking portion 206.

The unitary frame 201 is made of two single metal tubes that form two side shafts 208, two rearwardly disposed leg portions 210 and the rocking portion 206. A horizontal seat support shaft 212 connects the two side shafts 208. The horizontal support shaft 212 and the side shafts 208 define a seating area 212.

The curved rocking portion 206 includes a curved surface contacting base 214 that allows the chair 200 to rock back and forth. As for 10 and 100, the support portion 202 and the leg portions 204 are sized to allow the male to position himself under the support portion and the female.

Two angled linking rods 216 are connected to each side shaft 208 and to each leg portion 210 and provide rigidity and support to the frame 201. The linking rods 216 are positioned away from the male partner so as not to interfere with him while he is positioned under the chair 200. The curved surface contacting base 214 when combined with the natural resilience of the metallic material allows for rocking movement and also for small spring-like vertical movements of the support portion 202.

The seating area 212 is divided into two substantially symmetrical half-seats 218 made of comfortable flexible material, for example, leather, or vinyl. Each of the half seats 218 includes along two sides a series of eyelets 220 that allow lacing cord 222 to loop around the side shafts 208 and the horizontal support shaft 212. Each half-seat 218 is a generally convex shaped with two side panel portions 224 and a rear panel portion 226. The rear panel portion 226 forms a low backrest 228. The two half-seats 218 are spaced apart from each other, and are connected together by lacing along two opposing edges, which define a front seating gap 230 and central seating gap 232. Both gaps 230 and 232 are sized to allow for optimal engagement/disengagement of the genitals therethrough in a similar fashion to the openings and contours in the second embodiment 100. The side panels may be adapted to include pockets.

Although the present chair for copulating couples has been described with a certain degree of particularity, it is to be understood that the disclosure has been made by way of example only and that present invention is not limited to the features of the embodiments described and illustrated herein, but includes all variations and modifications within the scope of the present invention as hereinafter claimed.

I claim:

1. Chair for copulating couples, said chair having a support body and two legs attached to said support body, said chair comprising:
said support body for supporting a first couple member, said support body having at least one generally concave contour located in a support body edge, the genitals of said first couple member being located adjacent said contour during copulation and in contact with the genitals of a second couple member; and
a rocker portion for rocking said chair back and forth on a surface, said rocker portion being located on a surface contact portion of each leg, said rocking back and forth allowing sexual stimulation of each couple member.

2. The chair, according to claim 1, further includes a first generally concave contour.

3. The chair, according to claim 2, further includes a second generally concave contour.

4. The chair, according to claim 3, in which said contour includes a contour sidewall.

5. The chair, according to claim 4, in which said contour sidewall further includes a first arcuate edge.

6. The chair, according to claim 5, in which said first arcuate edge interconnects an upper support body surface with said contour sidewall.

7. The chair, according to claim 3, in which said contour sidewall further includes a second arcuate edge.

8. The chair, according to claim 7, in which said second arcuate edge interconnects a lower support body surface with said contour sidewall.

9. The chair, according to claim 3, in which said contour sidewall includes two arcuate edges, which interconnect said upper and lower support body surfaces.

10. The chair, according to claim 3, in which said contour is of sufficient size to allow said first and second couple members to comfortably position their genitals against said first contour during copulation.

11. The chair, according to claim 3, in which said contour includes a contour axis.

12. The chair, according to claim 3, in which said second contour is located in said support body edge.

13. The chair, according to claim 12, in which said second contour is opposite said first contour.

14. The chair, according to claim 13, in which said second contour has generally the same size as said first contour.

15. The chair, according to claim 1, in which said support body edge includes a first longitudinal edge portion.

16. The chair, according to claim 1, in which said support body edge includes a second longitudinal edge portion.

17. The chair, according to claim 16, in which said second longitudinal edge portion is located opposite said first longitudinal edge portion.

18. The chair, according to claim 17, in which said first and second longitudinal edge portions define a generally planar seat portion.

19. The chair, according to claim 18, in which said first longitudinal edge portion has a first height and said second longitudinal edge portion has a second height, said second height being larger than said first height.

20. The chair, according to claim 1, in which said support body edge further includes two connecting edge portions for connecting each leg thereto.

21. The chair, according to claim 20, in which said connecting edge portions are spaced apart, each leg depending therefrom.

22. The chair, according to claim 1, in which said support body further includes a first support body opening.

23. The chair, according to claim 22, in which said support body further includes a second support body opening.

24. The chair, according to claim 23, in which said support body opening includes a body opening sidewall.

25. The chair, according to claim 24, in which said body opening sidewall includes a first annular edge.

26. The chair, according to claim 25, in which said first annular edge interconnects said body opening sidewall to said upper support body surface.

27. The chair, according to claim 25, in which said body opening sidewall includes a second annular edge.

28. The chair, according to claim 27, in which said second annular edge interconnects said body opening sidewall to said lower support body surface.

29. The chair, according to claim 26, in which said body opening sidewall has two arcuate edges, which interconnect said lower and upper body surfaces.

30. The chair, according to claim 23, in which said support body opening has a body opening axis.

31. The chair, according to claim 11 or 30, in which said support body opening axis is parallel to said contour axis.

32. The chair, according to claim 23, in which said first support body opening is spaced apart from said second support body opening.

33. The chair, according to claim 32, in which said support body openings are located adjacent said first and second contours.

34. The chair, according to claim 33, in which said support body openings are located between each connecting portion and each of said contour.

35. The chair, according to claim 33, in which said support body openings are sized to allow the buttocks of said first couple member to be supported therein and to allow the genitals of said first and second members to fit therethrough.

36. The chair, according to claim 1, in which each leg includes: a distal leg portion connected to said surface contacting portion; a proximal leg portion; and an intermediate leg portion interconnecting said distal and proximal leg portions.

37. The chair, according to claim 36, in which said surface contacting portion defines a generally curved surface of sufficient size to allow said chair to rocking back and forth.

38. The chair, according to claim 37, in which said curved surface has an surface contacting axis about which said curved surface rocks, said axis being generally parallel to said surface.

39. The chair, according to claim 36, in which each leg includes a height adjusting member for adjusting the height of said support body relative to said surface.

40. The chair, according to claim 39, in which said height adjusting member is located in said proximal leg portion.

41. The chair, according to claim 40, in which said height adjusting member includes a plurality of bores for receiving a securing member therein.

42. The chair, according to claim 36, in which each leg includes a handle member, said handle member having: a recess located in said distal leg portion; a front gripping bar located in the intermediate leg portion; a rear gripping bar located in said intermediate leg portion; and a central gripping bar located in said intermediate leg portion, said central gripping bar interconnects said front and rear gripping bars.

43. The chair, according to claim 1, in which said support body is angled away from a horizontal support body plane towards said surface.
